(19) United States
(12) Patent Application Publication
(10) Pub. No.: US 2024/0140243 A1
(43) Pub. Date: May 2, 2024

(54) METHOD FOR PROVIDING ANCILLARY SERVICES

(71) Applicant: Gridlynx AB, Akersberga (SE)

(72) Inventors: Martin Lindahl, Akersberga (SE); Lars Herre, Solna (SE)

(73) Assignee: Gridlynx AB, Akersberga (SE)

(21) Appl. No.: 18/407,683

(22) Filed: Jan. 9, 2024

Related U.S. Application Data
(63) Continuation of application No. PCT/SE2022/050649, filed on Jun. 29, 2022.

(30) Foreign Application Priority Data
Jul. 19, 2021 (SE) 2150961-7

(51) Int. Cl. B60L 53/63; B60L 53/10; B60L 55/00; G05D 1/65; G05D 1/69; G05D 105/00; G05D 109/10

(52) U.S. Cl. CPC B60L 53/63; B60L 53/10; B60L 55/00; G05D 1/65; G05D 1/69; G05D 2105/57; G05D 2109/10

(57) ABSTRACT

The present invention relates to a method for providing ancillary services to an electrical grid. The ancillary services are related to frequency reserve provision, voltage and/or reactive power control and peak power reduction. The method is based a fleet of vehicles, partly driven by electrical power and comprises a step of changing the mode of operation for the vehicles and thereby altering the available electrical power in the electrical grid.

### CLAIM OF PRIORITY

This application is a continuation of and claims priority to International Application No. PCT/SE2022/050649 filed Jun. 29, 2022, and published as WO2023/003500 on Jan. 26, 2023, entitled, “METHOD FOR PROVIDING ANCILLARY SERVICES,” by Lindahl et al., which claims priority to Swedish Patent Application No. 2150961-7, filed Jul. 19, 2021, each of which is incorporated by reference herein in its entirety.

### FIELD OF THE INVENTION

The present invention relates to a method for providing ancillary services to an electrical grid.

### BACKGROUND OF THE INVENTION

With increasing renewable energy sources, e.g. wind and solar power, in the power grid, the connected inertia (rotating mass) decreases. This increases the probability and risk of, e.g., frequency drops in the electrical power grid. A lot of research efforts are focused on coping with this problem, for example with type-4 converters connected to wind turbines or battery energy storage. Other efforts are focused on controlling flexible loads (e.g. electric heating, air conditioning, home battery charging) to reduce consumption when the load is high.

However, a resource exists which can help to cope with the aforementioned problems, and which are not capable of being utilized today. Many vehicles with electric drivelines are connected to the electrical power grid today, and the trend is that more and more vehicles, and types of vehicles, will be connected in the future. The here presented invention is a method to utilize the inertia and flexibility of electrically powered vehicles as a flexible asset that is capable of providing ancillary services when using the here presented method. The method works by combining multiple vehicles into one or many fleets of vehicles, where it can be ensured that vehicles both arrive on time and provide one or more ancillary services to the electrical power system.

Transmission or distribution system operators operate and continuously expand ancillary service markets for service providers to contribute to improved power system operation, frequency quality, and—ultimately—renewable energy integration. The development of ancillary service markets, together with inventions such as the one presented here, are of utmost importance to achieve a stable and resilient future power system with a high share of renewable energy.

### OBJECT OF THE INVENTION

It is a further object of the present invention to provide an alternative to the prior art.

In particular, it may be seen as an object of the present invention to provide a method to provide ancillary services not in existence today which contributes to stronger and more resilient electrical grids which allows a larger degree of renewable energy sources in the electrical grid.

### SUMMARY OF THE INVENTION

Thus, the above described object and several other objects are intended to be obtained in a first aspect of the invention by providing a method to provide ancillary services related to frequency reserve provision, voltage and reactive power control, inertia, and peak power reduction in an electrical grid, the method may be based on
a fleet of vehicles being at least partly driven by electrical power provided by said electrical grid, wherein the torque of an electrical motor which controls the speed of each vehicle may be controllable, at least partially by the power consumed by each vehicle;
one or more activation signals, such as a request for changes in net power consumption for a provided time duration of the fleet of vehicles;
   the method may comprise
recurrently obtaining a present state, such as weight, speed, location, torque, net power consumption for at least some of said vehicles;
receiving or determining an activation signal including a required change in net power consumption (may be negative or positive) to be provided to the electrical grid and a required duration of said change in net power consumption;
determining a change of mode of operation for one or more of the vehicles based on a present state and a present mode of operation of the vehicles necessary to achieve the requirements in said activation signal, and
changing mode of operation for said one or more vehicles for the required duration to conform to the determined change of mode of operation, thereby altering the available electrical power in the electrical grid, to provide the ancillary service.

Thus, the above described object and several other objects are intended to be obtained in a first aspect of the invention by providing a method to provide ancillary services related to frequency reserve provision, inertia, and voltage control in an electrical grid, the method may be based on
a fleet of vehicles being at least partly driven by electrical power provided by said electrical grid, wherein the torque of an electrical motor which controls the speed of each vehicle may be controllable, at least partially by the power consumed by each vehicle;
one or more activation signals, such as a request for changes in net power consumption for a provided time duration of the fleet of vehicles;
   the method may comprise
recurrently obtaining a present state, such as weight, speed, location, torque, net power consumption for at least some of said vehicles;
receiving or determining an activation signal including a required change in net power consumption (may be negative or positive) to be provided to the electrical grid and a required duration of said change in net power consumption;
determining a change of mode of operation for one or more of the vehicles based on a present state and a present mode of operation of the vehicles necessary to achieve the requirements in said activation signal, and
changing mode of operation for said one or more vehicles for the required duration to conform to the determined change of mode of operation, thereby altering the available electrical power in the electrical grid, to provide the ancillary service.

In one embodiment of the invention the method is computer-implemented.

In one embodiment of the invention the method provides ancillary services related to extreme frequency events.

In some preferred embodiments of the invention, the method is based on a fleet of vehicles at least partly driven by electric power provided by an electrical grid. The ancillary service may be provided to fulfil one or more activation signals, such as a request from a transmission or distribution system operator. The fleet of vehicles may be controlled by one or many processors in a computer, and is at least partly adapted to provide ancillary services or balancing services related to frequency reserve provision, voltage and reactive power control and peak power reduction to an electrical grid. Based on one or more such requests, the state of the vehicles and the present mode of operation of the vehicles, determine one or more modes of operation for one or more of said vehicles so as to provide the requested ancillary service to the electrical grid in accordance with the activation signal from said transmission or distribution system operator.

In some other embodiments of the invention, the determination of an activation signal may comprise locally measuring the frequency of the electrical grid from which one or more of the vehicles consumes power and if the determined frequency is outside a predefined frequency range or the rate of change of frequency is outside a predefined range, determine one or more modes of operation for one or more of said vehicles so as to contribute or bring the frequency within the said range.

In some embodiments, one or more such as all of the vehicles of the fleet of vehicles may be trains, or any other type of electrical vehicle driven on railway which will here jointly be called trains. The trains may be operated with or without drivers, i.e. be operated automatically/autonomously or be operated by humans.

In other embodiments, one or more such as all of the vehicles of the fleet may be electric road vehicles, such as trucks, busses or cars which will here jointly be called road vehicles. The road vehicles may be operated with or without drivers, i.e. be operated automatically/autonomously or be operated by humans.

In further embodiments, the fleet of vehicles may be a combination of both trains and road vehicles, such as at least one vehicle is a train and at least one other vehicle is a road vehicle.

In preferred embodiments, each vehicle may be connected to the electrical grid by a current collector, arranged on each vehicle.

Optionally, the current collector may be a pantograph, such as a half-pantograph, a contact shoe or a third rail.

Optionally, the current collector may be a wireless current collector, such as an inductive power transfer.

Optionally, a power consumption flexibility of the vehicles may be determined, which flexibility can be exploited in order to meet a future received activation signal(s), said flexibility of the vehicles preferably comprising early/delay start and/or increase/decrease acceleration and/or coast vehicle (no propulsive power) and/or early/delay deceleration and/or brake to re-generate and/or decrease/increase set speed and/or dissipate energy in brake resistors.

Optionally, the method may be comprising preparing the fleet of vehicles to meet expected future activation signal(s) based on the flexibility.

Optionally, the change in mode of operation may cause at least one of the vehicles in the fleet of vehicles to perform an early start action or delay a start action in a predefined or calculated duration of time.

Optionally, the change in mode of operation may cause at least one of the vehicles in the fleet of vehicles to decrease or increase acceleration in a predefined or calculated duration of time.

Optionally, the change in mode of operation may cause at least one of the vehicles in the fleet of vehicles to coast (i.e. apply no propulsive power) in a predefined or calculated duration of time.

Optionally, the change in mode of operation may cause at least one of the vehicles in the fleet of vehicles to perform an early deceleration action or delay a deceleration action in a predefined or calculated duration of time.

Optionally, the change in mode of operation may cause at least one of the vehicles in the fleet of vehicles to dissipate energy in brake resistors in a predefined or calculated duration of time.

Optionally, the change in mode of operation may cause at least one of the vehicles in the fleet of vehicles to brake and by utilizing an electrical motor of said one or more vehicles re-regenerating power by operating said electrical motor(s) as generator(s) in a predefined or calculated duration of time, in order to provide power to the electrical grid.

Optionally, the change in mode of operation may cause at least one of the vehicles in the fleet of vehicles to decrease or increase set speed in a predefined or calculated duration of time.

Optionally, the fleet of vehicles may comprise at least two sub fleets of vehicles.

The invention relates in a second aspect to a system to provide ancillary services related to frequency reserve provision, voltage, inertia, and reactive power control and/or peak power reduction for an electrical grid which may comprise
one or more fleets of vehicles as described above,
one or more processors configured to carry out the method as described above, and
the fleet(s) of vehicles is/are connected and configured to provide ancillary services such as frequency reserve provision, voltage and reactive power control and peak power reduction to the electrical grid.

Optionally, the ancillary service providing system further comprising an energy storage power station, which may comprise at least one battery to store electric energy, wherein the fleet of vehicles and the energy storage power station may be electrically connected and configured to provide an ancillary service to the electrical grid.

This is particularly, but not exclusively advantageous as the ancillary service providing system can be coupled to existing systems for managing a fleet of vehicles, as the processor can be configured to cooperate with an existing processor.

Optionally, the ancillary service providing system further comprising a method for baseline power consumption, which computes or estimates the power consumption of the fleet(s) of vehicles in the undisturbed operation, i.e., without any change of mode of operation.

All aspects, embodiments and variations described herein can be combined with each other unless explicitly stated otherwise.

### BRIEF DESCRIPTION OF THE FIGURES

The method to provide ancillary services according to the invention will now be described in more detail with regards to the accompanying figures. The figures show ways of implementing the present invention and are not to be construed as being limiting to other possible embodiments falling within the scope of the attached claim set.

FIG. 1 schematically illustrates a fleet of vehicles being managed to provide ancillary services to an electrical grid according to the invention,

FIG. 2 schematically illustrates a process for providing ancillary services according to one embodiment of the invention,

FIG. 3 schematically illustrates a process for low frequency routines according to the invention,

FIG. 4A-D schematically illustrate another process for routines according to the invention, in particular FIG. 4A illustrates a process for high frequency routine, FIG. 4B illustrates a process for a low voltage routine, FIG. 4C illustrates a process for a high voltage routine and FIG. 4D illustrate a peak power routine;

FIG. 5 schematically illustrates a mode of action process according to the invention,

FIG. 6 schematically illustrates another mode of action process according to the invention,

FIG. 7 schematically illustrates another mode of action process according to the invention,

FIG. 8 schematically illustrates another mode of action process according to the invention,

FIG. 9 schematically illustrates another mode of action process according to the invention,

FIG. 10 schematically illustrates another mode of action process according to the invention,

FIG. 11 schematically illustrates another mode of action process according to the invention,

FIG. 12 schematically illustrates another mode of action process according to the invention,

FIG. 13 schematically illustrates a generic feedback control architecture according to the invention,

FIG. 14 schematically illustrates a more detailed feedback control architecture according to the invention.

### DETAILED DESCRIPTION OF AN EMBODIMENT

The invention can be implemented by means of hardware, software, firmware or any combination of these. The invention or some of the features thereof can also be implemented as software running on one or more data processors and/or digital signal processors. Hence, the method according to the invention may be computer-implemented.

The individual elements of an embodiment of the invention may be physically, functionally and logically implemented in any suitable way such as in a single unit, in a plurality of units or as part of separate functional units. The invention may be implemented in a single unit, or be both physically and functionally distributed between different units and processors. The physical units and processors may be located close together or at different geographic locations.

In renewable energy dominated energy systems, power generation in synchronous generators is replaced by decentralized and converter-connected renewable energy sources. At the same time, rotating loads are replaced by power electronic devices. Less reliable power plants not only put the power balance at risk, but also worsen the frequency quality in the power system and drive the need for frequency services and increased inertia. Inertia is the backbone of a stable frequency in the system: The less inertia, the higher the risk that a frequency deviation will result in blackouts and load shedding. While power system inertia is decreasing with less rotating baseload generation, the market size of frequency ancillary services keeps increasing. At the same time, the development of power electronic converters has made significant advances. A fleet of electrically powered vehicles is moving mass, which is connected to the power system by power electronic converters and can provide ancillary services. The invention is to use grid-connected infrastructure with kinetic energy. Fleets of electric vehicles can react to power system needs, provide ancillary services related to frequency reserve provision and voltage control, inertia, and other extreme frequency events, and ultimately promote integration of higher shares of renewable energy and decarbonization of the power system.

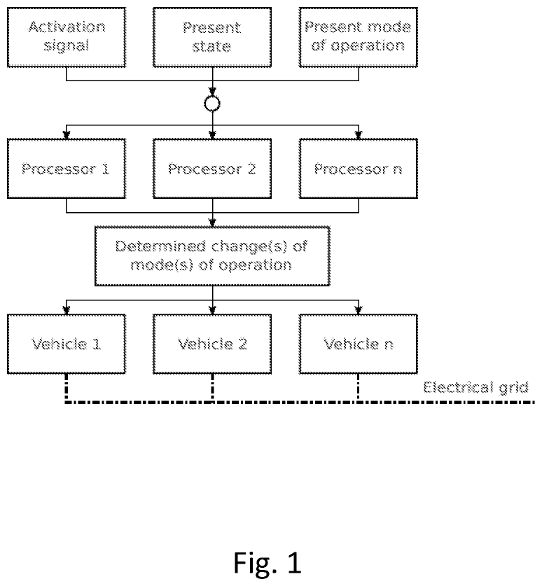

With reference to FIG. 1, illustrating a fleet of vehicles 3, which in this specific embodiment is a fleet of trains running on a set of rails and connected to an electrical grid 2. The fleet of trains are controlled by one or more processors, and said one or more processors causes at least one train in the fleet of trains to change mode of operation 8 based on an activation signal 5 (a received request or a locally computed activation signal) and a present state 7 for at least a part of the trains in the fleet of trains and a present mode of operation 8 for at least a part of the trains in the fleet of trains for provision of ancillary services 1 to the electrical grid 2.

In embodiments according to the invention the fleet of vehicles 3, e.g. two vehicles, that are used in a method according to the invention are connected to the same electrical grid 2 and at the same frequency. However, the vehicles do not need to be positioned geographically close to each other. A method according to the invention is not geographically limited and as long as the two vehicles are at the same frequency and connected to the same electrical grid 2 they can be used in a method according to the invention. Hence, the vehicles could be positioned 10 km, 50 km, 100 km, 1000 km, or even more km apart. The vehicles could additionally be positioned adjacent to each other.

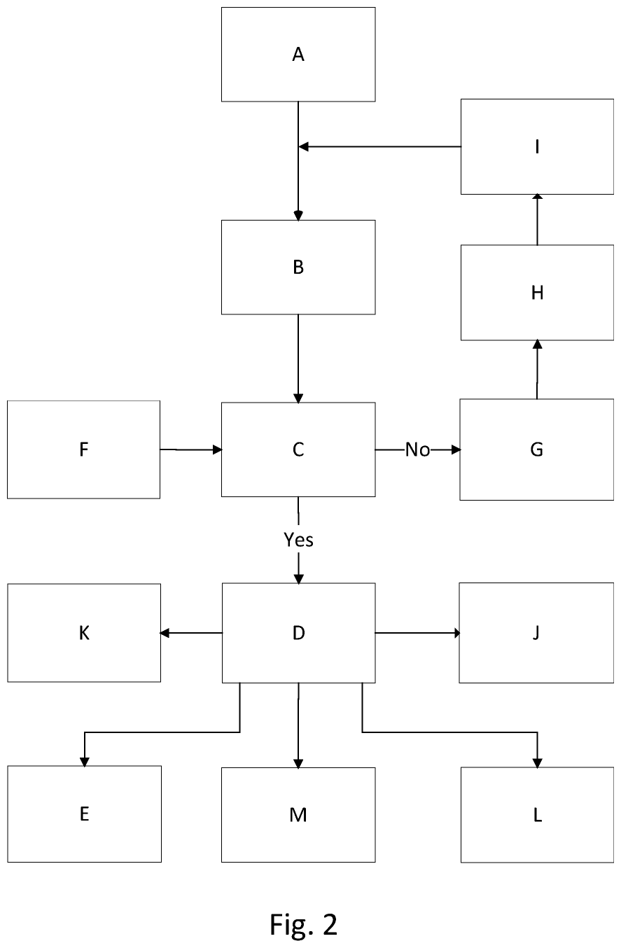

With reference to FIG. 2, schematically illustrating a process flow diagram concerning preparation of a fleet of vehicles 3 to a future request input and decide based on said input a routine. In the illustrated flowchart A is start, B is collection of state(s) 7 of vehicle(s) 4, C is check for arrival of activation signal such as request from a transmission or distribution system operator, or a local activation signal such as but not limited to an activation signal based on measuring locally the frequency of the electrical grid 2, D is characterisation of activation signal as either low or high frequency, or low or high voltage, or peak power, or peak power at extreme frequency events, E is low frequency routine, F is request input from a transmission or distribution system operator, G is update of the priority stack and determination of available flexibility, such as prioritising the vehicles 4 in order of flexibility of each vehicle's 4 present state 7 in relation to its timetable or similar, H is manage readiness to be prepared for expected future activation signal(s) 5, I is send commands to increase readiness, J is high frequency routine, K is low voltage routine, L is high voltage routine and M is peak power routine.

The term ‘extreme frequency events’ may refer to events in a power system in which the frequency drops or increases to alarming levels, i.e. outside the normally tolerated frequency band. In explementary embodiments the method according to the invention provides ancillary services related to extreme frequency such as load shedding.

A method according to the invention provides ancillary service(s) to an electrical grid. The types of ancillary services can be frequency provision, voltage and reactive power control, inertia, peak power reduction, and valley filling in an electrical transmission and/or distribution grid.

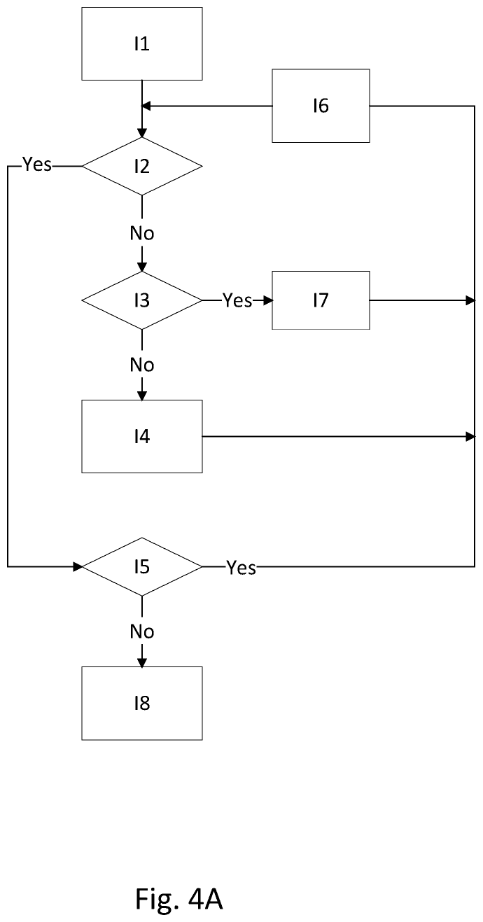

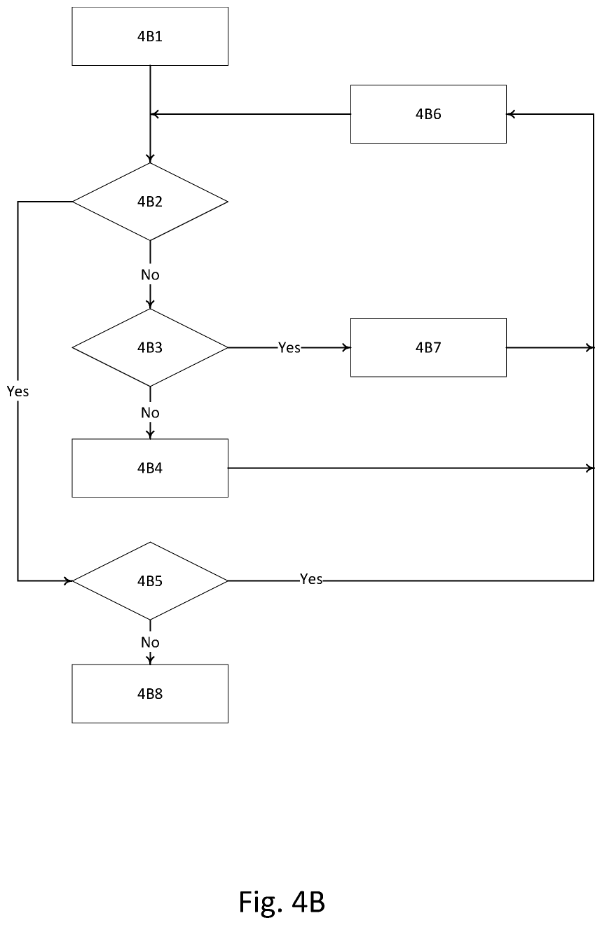

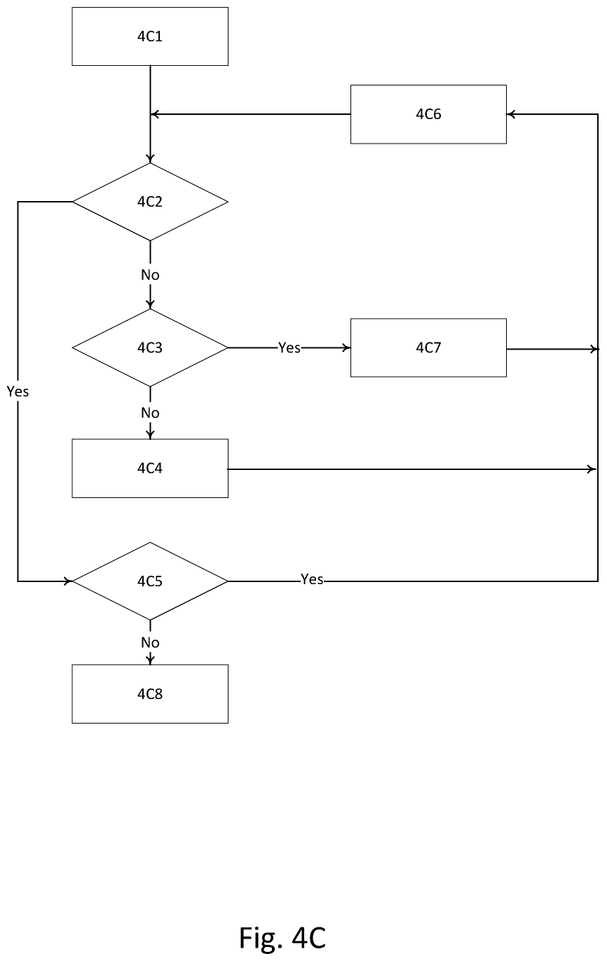

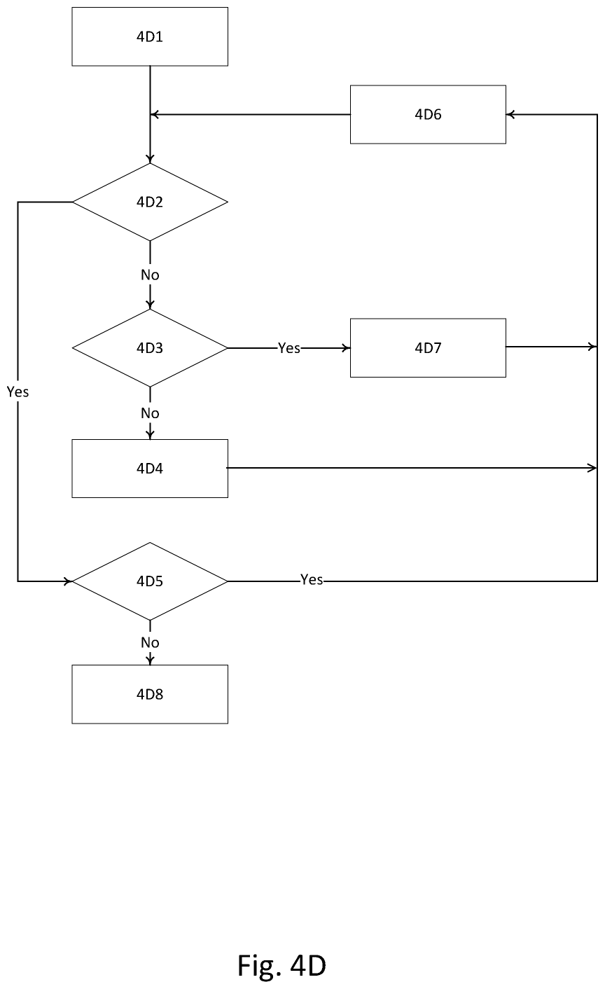

In a preferred embodiment of the invention, the method is based on a fleet of vehicles 3 being several trains, and said trains at least partly driven by electrical power provided by or connected to said electrical grid 2, and further based on one or more activation signals 5, such as a request from a transmission or distribution system operator, or a local activation signal such as but not limited to an activation signal based on measuring locally the frequency of the electrical grid 2. The fleet of trains can be controlled by a processor in a computer, and is at least partly adapted to provide ancillary services 1 or balancing services related to frequency reserve provision, voltage and reactive power control and peak power reduction in an electrical grid 2. Commonly, an electrical grid 2 is a system designed to transmit electric energy and supply individuals and/or companies with electricity. As illustrated in FIG. 2, the method comprises recurrently obtaining a present state 7, such as weight, speed, location, torque, net power consumption for at least some of said trains 4. The information may be relevant for determining potential mode of operations 8 for said train 4. Further, receiving or determining an activation signal 5 including a required change in power net consumption (may be negative or positive) to be provided to the electrical grid 2 and a required duration of said change in power net consumption. The activation signal 5 may be provided by the transmission or distribution system operator or be determined locally. The signal may include the required amount of power to be delivered to the electrical grid 2 or the amount of power to be extracted from the electrical grid 2 including the amount of time wherein the service should be provided, such that the fleet of vehicles 3 contributes to bring the frequency of the electrical grid 2 towards nominal conditions and optimally to within nominal conditions. The method further comprises, determining a change of mode of operation 8 for one or more of the vehicles 4 based on a present state 7 and a present mode of operation 8 of the vehicles 4 necessary to achieve the requirements in said activation signal 5, and changing mode of operation 8 for said one or more vehicles 4 for the required duration to conform to the determined change mode of operation 8, thereby altering the available electrical power in the electrical grid 2, to provide the ancillary service 1. In FIG. 4 to FIG. 11 examples of possible mode of operations 8 are illustrated. The best mode of operation 8 for each vehicle 4 is determined based on the present state 7 for said vehicle 4 and the requirement in the activation signal 5. Each vehicle 4 may, during different sub-intervals of the duration the ancillary service 1 should be provided, be in different modes of operation, in order to meet the requirement in the request in a suitable way.

In some embodiments, the activation signal 5 is determined by measuring locally the frequency of the electrical grid 2 from which one or more of the vehicles 4 consumes power, and if the determined frequency is outside a predefined frequency range or the rate of change of frequency is outside a predefined range, determine one or more modes of operation for one or more of said vehicles 4 so as to contribute or bring the frequency within the said range.

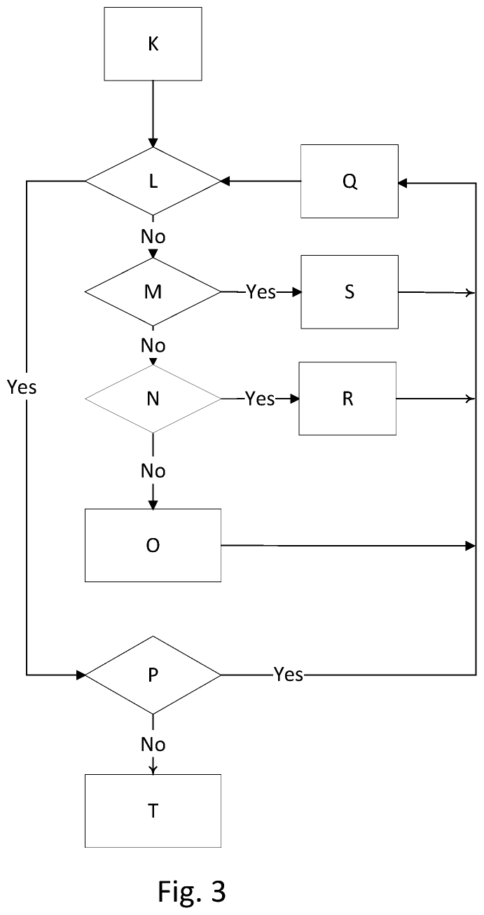

With reference to FIG. 3, schematically illustrating a process flow diagram concerning a low frequency routine for a fleet of vehicles 3, wherein K is low frequency routine activated, L is a check for power level fulfilment, M is a check for power consumption reduction, N is a check for regeneration of power to electrical grid 2, O is requested power level cannot be provided, P is a check if the low frequency routine is still active, Q is monitoring of state(s) 7 and collection of feedback, R is sending commands to one or more vehicles 4 in the fleet of vehicles 3 to provide power to electrical grid 2, S is sending commands to one or more vehicles 4 in the fleet of vehicles 3 to reduce power consumption and T is sending free commands and return to original settings.

With reference to FIG. 4A, schematically illustrating a process flow diagram concerning a high frequency routine for a fleet of vehicles 3, wherein 11 is high frequency routine activated, 12 is a check for power level fulfilment, 13 is a check for power consumption increase, 14 is requested power level cannot be provided, 15 is a check if the high frequency routine is still active, 16 is monitoring of state(s) 7 and collection of feedback, 17 is sending commands to one or more vehicles 4 in the fleet of vehicles 3 to increase power consumption and 18 is sending free commands and return to original settings.

With reference to FIG. 4B, schematically illustrating a process flow diagram concerning a low voltage routine for a fleet of vehicles 3, wherein 4B1 is low voltage routine activated, 4B2 is a check for reactive power level fulfilment, 4B3 is a check for reactive power consumption decrease, 4B4 is requested reactive power level cannot be provided, 4B5 is a check if the low voltage routine is still active, 4B6 is monitoring of state(s) 7 and collection of feedback, 4B7 is sending commands to one or more vehicles 4 in the fleet of vehicles 3 to decrease reactive power consumption and 4B8 is sending free commands and return to original settings.

With reference to FIG. 4C, schematically illustrating a process flow diagram concerning a high voltage routine for a fleet of vehicles 3, wherein 4C1 is high voltage routine activated, 4C2 is a check for reactive power level fulfilment, 4C3 is a check for reactive power consumption increase, 4C4 is requested reactive power level cannot be provided, 4C5 is a check if the high voltage routine is still active, 4C6 is monitoring of state(s) 7 and collection of feedback, 4C7 is sending commands to one or more vehicles 4 in the fleet of vehicles 3 to increase reactive power consumption and 4C8 is sending free commands and return to original settings.

With reference to FIG. 4D, schematically illustrating a process flow diagram concerning a peak power routine for a fleet of vehicles 3, wherein 4D1 is peak power routine activated, 4D2 is a check for power reduction level fulfilment, 4D3 is a check for power consumption decrease, 4D4 is requested power reduction level cannot be provided, 4D5 is a check if the peak power routine is still active, 4D6 is monitoring of state(s) 7 and collection of feedback, 4D7 is sending commands to one or more vehicles 4 in the fleet of vehicles 3 to decrease power consumption and 4D8 is sending free commands and return to original settings.

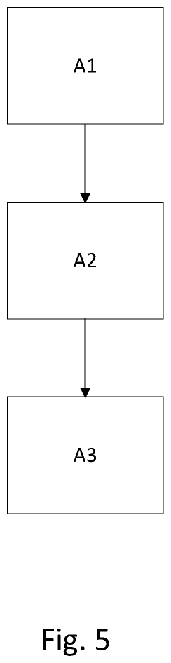

With reference to FIG. 5, schematically illustrating a process flow diagram concerning a change in mode of operation 8 for at least a vehicle 4 in a fleet of vehicles 3, wherein A1 is receiving a delayed start action, A2 is an action to prevent at least a vehicle 4 in a fleet of vehicles 3 from starting in a predefined or calculated amount of time and A3 is enabling start procedure of said vehicle(s) 4 and return to original settings.

Alternatively, with reference to FIG. 5, schematically illustrating a process flow diagram concerning a change in mode of operation 8 for at least a vehicle 4 in a fleet of vehicles 3, wherein A1 is receiving an early start action, A2 is an action to activate at least a vehicle 4 in a fleet of vehicles 3 to start a predefined or calculated amount of time early and A3 is enabling start procedure of said vehicle(s) 4 and return to original settings.

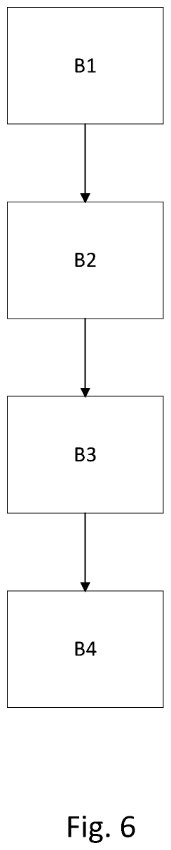

With reference to FIG. 6, schematically illustrating a process flow diagram concerning another change in mode of operation 8 for at least a vehicle 4 in a fleet of vehicles 3, wherein B1 is receiving a decreased acceleration action, B2 decreasing acceleration set-point by a predefined or calculated amount, B3 is sustain limited power for said vehicle(s) 4 in a predefined or calculated amount of time, B4 is enabling original vehicle performance and return to original settings.

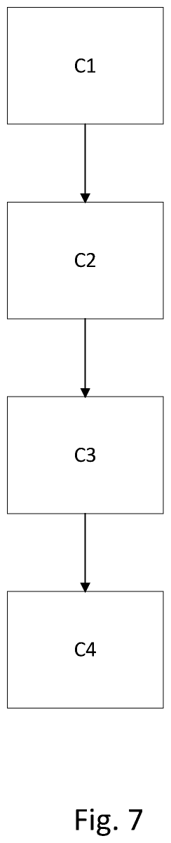

With reference to FIG. 7, schematically illustrating a process flow diagram concerning yet another change in mode of operation 8 for at least a vehicle 4 in a fleet of vehicles 3, wherein C1 is enabling coast action (i.e. apply no propulsive power) instead of original vehicle performance, C2 is reducing vehicle(s) 4 power output to minimum, C3 is sustain reduction for a predefined or calculated amount of time and C4 is enabling original vehicle performance and return to original settings.

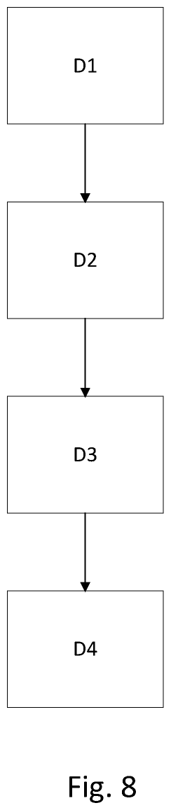

With reference to FIG. 8, schematically illustrating a process flow diagram concerning yet another change in mode of operation 8 for at least a vehicle 4 in a fleet of vehicles 3, wherein D1 is enabling an early or delayed deceleration action, D2 is activation of break power set-point, D3 is regulation of braking power for arrival to a predefined point or location at a predefined or calculated time and D4 is disabling of brake power set-point and return to original settings.

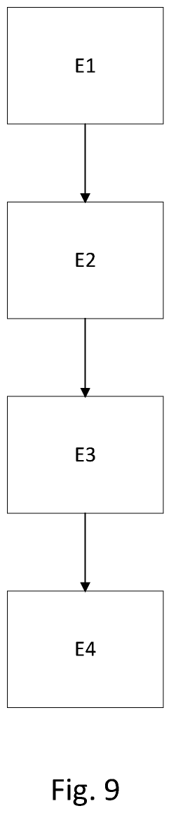

With reference to FIG. 9, schematically illustrating a process flow diagram concerning yet another change in mode of operation 8 for at least a vehicle 4 in a fleet of vehicles 3, wherein E1 is enabling regeneration of power to electrical grid 2 action, E2 is activation of a predefined or calculated brake power set-point, E3 is sustain predefined or calculated brake power set-point in a predefined or calculated amount of time and E4 is disabling brake power set-point and return to original settings.

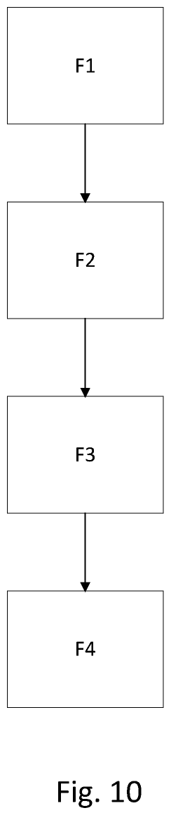

With reference to FIG. 10, schematically illustrating a process flow diagram concerning yet another change in mode of operation 8 for at least a vehicle 4 in a fleet of vehicles 3, wherein F1 is receiving an increased acceleration action, F2 is increasing acceleration set-point by a predefined or calculated amount, F3 is sustain predetermined or calculated increased acceleration set-point in a predefined or calculated amount of time and F4 is disabling increased acceleration and return to original settings.

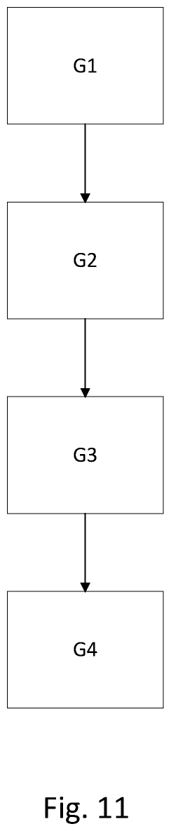

With reference to FIG. 11, schematically illustrating a process flow diagram concerning yet another change in mode of operation 8 for at least a vehicle 4 in a fleet of vehicles 3, wherein G1 is receiving an increased speed action, G2 is increasing speed set-point by a predefined or calculated amount, G3 is sustain predefined or calculated increased speed set-point for a predefined or calculated amount of time and G4 is disabling increased speed set-point and return to original settings.

Alternatively, with reference to FIG. 11, schematically illustrating a process flow diagram concerning yet another change in mode of operation 8 for at least a vehicle 4 in a fleet of vehicles 3, wherein G1 is receiving a decreased speed action, G2 is decreasing speed set-point by a predefined or calculated amount, G3 is sustain predefined or calculated decreased speed set point-point for a predefined or calculated amount of time and G4 is disabling decreased speed set-point and return to original settings.

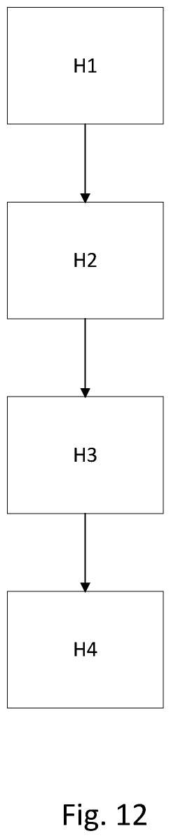

With reference to FIG. 12, schematically illustrating a process flow diagram concerning yet another change in mode of operation 8 for at least a vehicle 4 in a fleet of vehicles 3, wherein H1 is receiving an action for burning energy in brake resistors, H2 is activate brake choppers to burn energy in brake resistors, H3 is sustain brake choppers active for a predefined or calculated amount of time and H4 is disabling brake choppers and return to original settings.

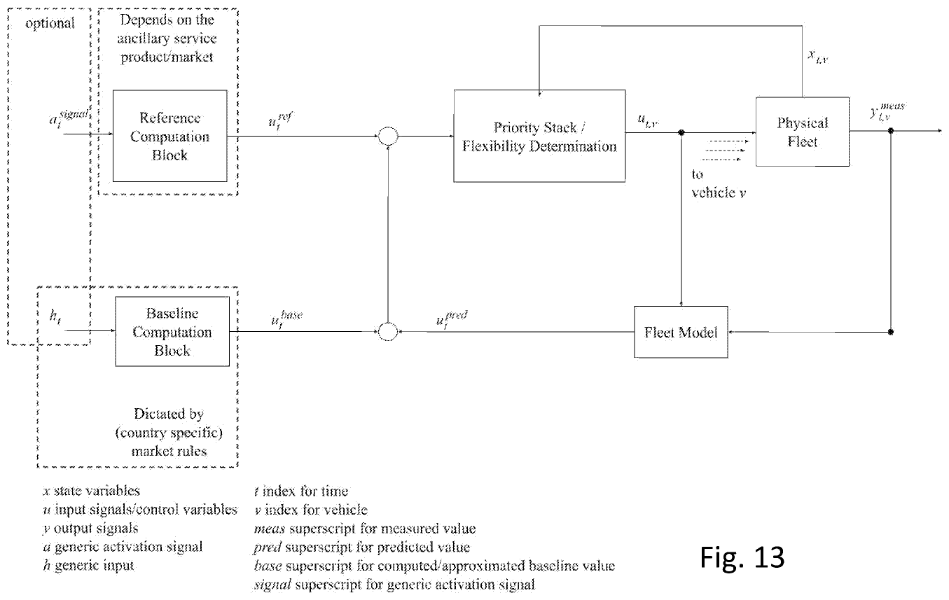

With reference to FIG. 13, schematically illustrating the generic feedback control architecture according to the invention, where an activation signal aₜ^{signal} (5) is used in the reference computation block to compute the reference control variable uₜ^{ref} at time instant t. Together with the state(s) 7 x_{t,v} of one or more such as all vehicles 4 v, the priority stack determines the available flexibility, such as prioritising the vehicle(s) 4 in order of flexibility of each vehicle's 4 present state 7 in relation to its timetable or similar, and sends individual control variables u_{t,v} to one or more such as all vehicles 4 v in the physical fleet of vehicles 3. The individual control variables u_{t,v} are also sent to a fleet model in case of measurement bottlenecks or disconnection. From the physical fleet of vehicles 3, the outputs are measured and fed back, through the fleet model if needed, as prediction variable Uₜ^{pred}. The system operator of the electrical grid 2 may require to react to a baseline signal for one or more of the ancillary services 1. The variable coming from the baseline computation block is added to uₜ^{pred}, and the resulting variable is added to uₜ^{ref} in a closed loop.

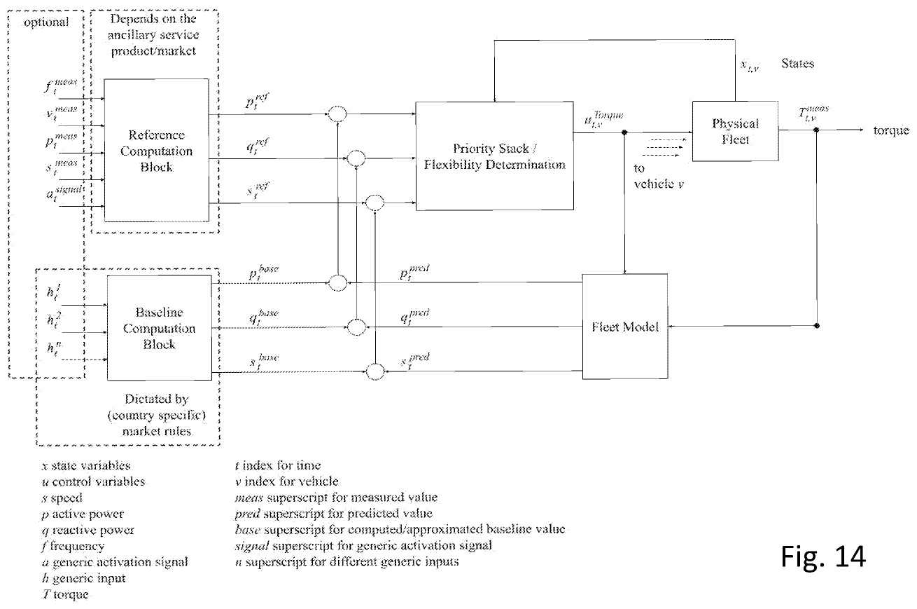

With reference to FIG. 14, schematically illustrating the more detailed feedback control architecture according to the invention, where, in addition to the description of FIG. 13, the activation signal 5 aₜ^{signal} may contain one or more of the following measurements or signals: the electrical frequency of the electrical grid 2 fₜ^{meas}, the local voltage at the connection point of the closest current collector vₜ^{meas}, the maximum or average power consumption pₜ^{meas}, the maximum or average speed sₜ^{meas}, or any other generic activation signal 5 aₜ^{signal}. The reference control variables include the active power pₜ^{ref}, reactive power qₜ^{ref} and speed s_{t,v}^{ref}. The individual control variable controls the torque at each vehicle 4. The feedback signals and optional baseline signals include the active power, reactive power and speed properties.

### LIST OF REFERENCE SYMBOLS USED

1 Ancillary service
2 Electrical grid
3 Fleet of vehicles
4 Vehicle
5 Activation signal
6 Current collector
7 State
8 Mode of operation

1. A method to provide ancillary services related to frequency reserve provision, voltage and/or reactive power control, inertia, and peak power reduction in an electrical grid, the method comprises:
recurrently obtaining a present state for at least some vehicles of a fleet of vehicles being at least partly driven by electrical power provided by the electrical grid, wherein torque of one or more electrical motors which controls speed of each vehicle of the fleet of vehicles is at least partly controllable by power consumed by each vehicle;
receiving or determining an activation signal including a required change in net power consumption to be provided to the electrical grid and a required duration of the required change in power net consumption;
recurrently determining a change of mode of operation for one or more of the vehicles based on a present state and a present mode of operation of the vehicles necessary to achieve the required change in net power consumption defined by the activation signal; and
changing mode of operation for the one or more vehicles for the required duration to conform to the determined change of mode of operation thereby altering available electrical power in the electrical grid to provide the ancillary service.

2. The method according to claim 1, wherein the present state is at least one selected from the group consisting of weight, speed, location, torque, and net power consumption.

3. The method according to claim 1, wherein each vehicle of the one or more vehicles is in different modes of operation at different sub-intervals of the required duration.

4. The method according to claim 1, wherein receiving or determining the activation signal comprises:
measuring locally a frequency of the electrical grid, from which the one or more of the vehicles consumes power; and
if the measured frequency is outside a predefined frequency range or a rate of change of the frequency is outside a predefined range, determining one or more modes of operation for the one or more vehicles so as to contribute or bring the frequency within the predefined frequency range.

5. The method according to claim 1, wherein all vehicles of the fleet of vehicles are trains.

6. The method according to claim 1, wherein all vehicles of the fleet of vehicles are road vehicles selected from the group consisting of trucks, busses and cars.

7. The method according to claim 1, wherein
the fleet of vehicles comprises a first sub-fleet of vehicles and a second sub-fleet of vehicles;
all vehicles of the first sub-fleet of vehicles are trains; and
all vehicles of the second sub-fleet of vehicles are road vehicles selected from the group consisting of trucks, busses and cars.

8. The method according to claim 1, wherein each vehicle of the fleet of vehicles is connected to the electrical grid by a current collector arranged on each vehicle.

9. The method according to claim 8, wherein the current collector is a wireless current collector.

10. The method according to claim 8, wherein the current collector is a pantograph.

11. The method according to claim 1, further comprising:
determining a power consumption flexibility of each vehicle of the fleet of vehicles; and
exploiting the power consumption flexibility to meet a future received or determined activation signal.

12. The method according to claim 11, further comprising preparing the fleet of vehicles to meet expected a future activation signal based on the power consumption flexibilities.

13. The method according to claim 1, wherein the change in mode of operation causes at least one of the vehicles in the fleet of vehicles to delay a start action or execute a start action early for a predefined or calculated duration of time after or before a scheduled time, wherein the scheduled time at least in part is based on:
a departure time according to a timetable;
an estimated departure time had the vehicle been early or late in relation to a timetable; or
an estimated departure time for a vehicle operating without timetable.

14. The method according to claim 1, wherein the change in mode of operation causes at least one of the vehicles in the fleet of vehicles to decrease or increase acceleration in a predefined or calculated duration of time.

15. The method according to claim 1, wherein the change in mode of operation causes at least one of the vehicles in the fleet of vehicles to coast in a predefined or calculated duration of time.

16. The method according to claim 1, wherein the change in mode of operation causes at least one of the vehicles in the fleet of vehicles to delay a deceleration action or execute a deceleration action early for a predefined or calculated duration of time after or before a scheduled time, wherein the scheduled time at least in part is based on
an arrival time according to a timetable;
an estimated arrival time had the vehicle been early or late in relation to a timetable; or
an estimated arrival time for a vehicle operating without timetable.

17. The method according to claim 1, wherein the change in mode of operation causes at least one of the vehicles in the fleet of vehicles to dissipate energy in brake resistors in said one or more vehicles in a predefined or calculated duration of time.

18. The method according to claim 1, wherein the change in mode of operation causes at least one of the vehicles in the fleet of vehicles to brake and by utilizing the one or more electrical motors of the one or more vehicles re-generating power by operating the one or more electrical motors as generator(s) in a predefined or calculated duration of time in order to provide power to the electrical grid.

19. The method according to claim 1, wherein the change in mode of operation causes at least one of the vehicles in the fleet of vehicles to decrease or increase set speed in a predefined or calculated duration of time.

20. A system to provide ancillary services related to frequency reserve provision, voltage, inertia, and reactive power control and/or peak power reduction for an electrical grid, the system comprises:
a fleet of vehicles being at least partly driven by electrical power provided by the electrical grid, wherein torque of one or more electrical motors which controls speed of each vehicle of the fleet of vehicles is at least partly controllable by power consumed by each vehicle;
one or more processors configured to
recurrently obtain a present state for at least some vehicles of a fleet of vehicles being at least partly driven by electrical power provided by the electrical grid, wherein torque of one or more electrical motors which controls speed of each vehicle of the fleet of vehicles is at least partly controllable by power consumed by each vehicle;
receive or determine an activation signal including a required change in net power consumption to be provided to the electrical grid and a required duration of the required change in power net consumption;
recurrently determine a change of mode of operation for one or more of the vehicles based on a present state and a present mode of operation of the vehicles necessary to achieve the required change in net power consumption defined by the activation signal; and
change mode of operation for the one or more vehicles for the required duration to conform to the determined change of mode of operation thereby altering available electrical power in the electrical grid to provide the ancillary service;
wherein the fleet of vehicles is connected and configured to provide an ancillary service to the electrical grid.

21. The system according to claim 20, wherein the ancillary service is at least one selected from the group consisting of frequency reserve provision, voltage and reactive power control and peak power reduction.
